(19) United States
(12) Patent Application Publication
(10) Pub. No.: US 2003/0233775 A1
(43) Pub. Date: Dec. 25, 2003

(54) Illuminated checkout divider with motion detector

(76) Inventor: Ed Klopfer, Sarasota, FL (US)

Correspondence Address: Irvin L. Groh, Gifford, Krass, Groh, Sprinkle, Anderson, & Citkowski, P.C., 280 N. Old Woodward Avenue, Suite 400, Birmingham, MI, 48009-5394, US

(21) Appl. No.: 10/437,840

(22) Filed: May 14, 2003

Related U.S. Application Data
(60) Provisional application No. 60/391,256, filed on Jun. 24, 2002.

(51) Int. Cl. G09F 13/04; G09F 13/00

(52) U.S. Cl. 40/564; 40/442

(57) ABSTRACT

A divider bar for checkout counters includes a backlighting arrangement that senses motion occurring, for example, when the customers approach the checkout station or when the bar is moved for use by a customer. In the preferred embodiment the illumination serves to call attention to the advertising displayed within the divider bar. The bar is elongated and transparent with a polygonal, preferably rectangular or square cross section. At least one end of the bar has end caps equipped with a motion detector in close proximity that activate sources of illumination to emphasize advertising which can be viewed through the transparent walls of the divider bar. The circuitry and source of illumination is supported by a plate, which slides loosely and is positioned diagonally within the rectangular cross section of the bar. The transparent plate acts also to hold panels or sheets of advertising in position. The replaceable advertising messages are formed on sheets having at least portions that are capable of being illuminated from the rear.

### REFERENCE TO RELATED APPLICATION

This application claims priority from U.S. Provisional Patent Application Serial No. 60/391,256, filed Jun. 24, 2002, the entire content of which is incorporated herein by reference.

### FIELD OF THE INVENTION

This invention relates to dividers for use at merchandise checkout counters and more particularly to such dividers incorporating changeable advertising messages.

### BACKGROUND OF THE INVENTION

Typical checkout stations, at grocery stores and super markets, for example, include a movable conveyer upon which shoppers place items to be purchased. Selected articles of merchandise are placed on the conveyer, which is movable at the control of the cash register operator to bring the merchandise within reach for processing at the cash register station.

While the order of one customer is being processed, another customer may place a divider, if available, transversely on the conveyer to separate their purchases. The divider maintains the selected merchandise of the two customers separated and is removed by the cash register operator after the first customer's merchandise has been processed. The divider typically is a piece of material such as molded hard plastic and may carry the name of the establishment and functions solely as a means of dividing merchandise.

To enhance versatility, some patented dividers provide for changeable advertising. For example, U.S. Pat. No. 4,534,126, entitled “Check-Out Counter Divider,” teaches an elongated hollow body defining an elongated opening and having a plurality of faces which are at least partially transparent to visible light for displaying advertising positioned within the opening from all faces of the divider. Removable closures on each end of the body allow easy replacement of the advertising within the body. The closures are skid-resistant and a weight is disposed within the body so that the counter divider resists rolling and displacement. Although the disclosed divider provides for changeable advertising, no provision is made for attracting attention to the material being advertised.

U.S. Pat. No. 5,450,926, entitled “Checkout Counter Order Divider Including Merchandise To Be Purchased,” describes a checkout counter order divider bar including merchandise to be purchased, which is displayed through transparent walls of the divider bar. A customer signals an operator at the checkout counter orally or visually that he/she wants to buy the merchandise in the divider bar or by activating a signaling device on the order divider bar.

At least one divider bar including internal backlighting, U.S. Pat. No. 5,933,994, entitled “Retail Checkout Divider Adapted To Receive Strips With Indicia Displayed Thereon”, describes a retail checkout divider in the form of a transparent fixture having a hollow interior. The interior of the fixture has holders forming slots adapted to receive strips with indicia displayed thereon. The strips are held within the slots by either flexible cylinders or end caps. In a further embodiment, a light source is provided within the fixture. Using this embodiment, display strips formed, for example, of translucent material, may be backlit, to produce a more striking appearance. It is contemplated that the light source can be powered by either batteries or a solar cell.

Although the '994 discloses an illuminated embodiment, continuous-duty lamps will require frequent maintenance. If batteries are used, they will wear out early, creating problems with battery changing. Solar cells are expensive, and unless the bar is provided with numerous cells or oriented properly, the unit may not work or may glow too dimly to be effective. Accordingly, the need remains for an improved, backlit divider bar.

### SUMMARY OF THE INVENTION

It is desirable and an object of the invention to provide a merchandise divider for use on moveable conveyors at checkout stations that are illuminated to attract attention and which are activated to the illuminated stage by customers approaching the checkout stations or movement of the divider by the customer.

It is another object of the present invention to provide a divider for a checkout station that acts as an advertising outlet with the advertising being changeable.

It is another object of the checkout counter divider having a plurality of faces for displaying different advertising messages from each of the faces.

It is yet a further object of the checkout counter divider to provide illumination, which occurs when customers approach the checkout station or when the bar is moved for use by a customer, and wherein the illumination is blinking to call attention to the advertising displayed within the divider bar.

These objectives are met with the present invention through a divider bar provided for checkout counters, which can be illuminated, and in which the illumination occurs when customers approach the checkout station or when the bar is moved for use by a customer. The illumination serves to call attention to the advertising displayed within the divider bar.

In the preferred embodiment, the bar is elongated and transparent with a rectangular/square cross section. At least one end of the bar has end caps with a motion detector in close proximity that activate sources of illumination to emphasize advertising which can be viewed through the transparent walls of the divider bar. The circuitry and source of illumination are mounted on a printed-circuit board which slides into the housing and is positioned diagonally therewithin.

The transparent housing acts also to the advertising in position. The replaceable advertising messages are preferably formed on one sheet folded into a plurality of sections that are capable of being illuminated from the rear. Separate sheets may alternatively be used. As a further option, the sheets can be formed as two units each made up of a pair of sheets with a single fold line between.

### BRIEF DESCRIPTION OF THE DRAWINGS

FIG. 1 is a perspective view of the preferred embodiment of the checkout counter divider embodying the invention;

FIG. 2 is a perspective view of one end of the checkout counter divider with an end removed and contents partially pulled out of position;

FIG. 3 is a cross-sectional view of the checkout counter divider;

FIG. 4 shows a preferred physical circuit-board layout;

FIG. 5 is an elevation view of an end portion of the divider seen in FIGS. 1 and 2;

FIG. 6 is a cross-sectional view similar to FIG. 3 showing an alternative form of material within the divider; and

FIG. 7 is a circuit diagram illustrating important electrical components associated with the invention.

### DETAILED DESCRIPTION OF THE INVENTION

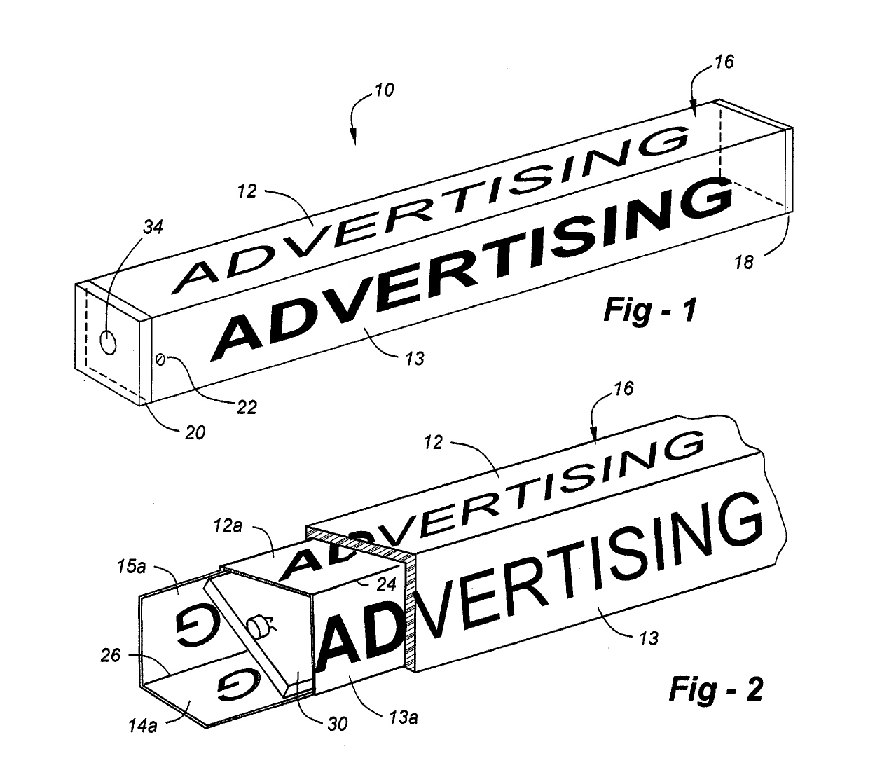

A checkout counter divider according to the invention is shown in FIG. 1 and designated generally at 10. The divider 10 is generally elongated and has a rectangular cross-section. In the preferred embodiment the cross-section is square so that the sidewalls 12, 13, 14 and 15 are of equal size.

The sidewalls preferably are transparent and form an elongated tube 16 which is closed at one end by a transparent wall 18 fixed in position with adhesive or the like, and closed at the other end using a removable plug 20 held in position by a press fit or a set screw 22 as seen in FIG. 1.

The tube 16 is of a length on the order of 12 to 20 inches or thereabouts to accommodate the width of the conveyor counter on which it is to be used and can be fabricated of separate sidewalls or extruded as a continuous tube. Both tube 16 and end wall 18 are preferably made of a similar transparent plastic material.

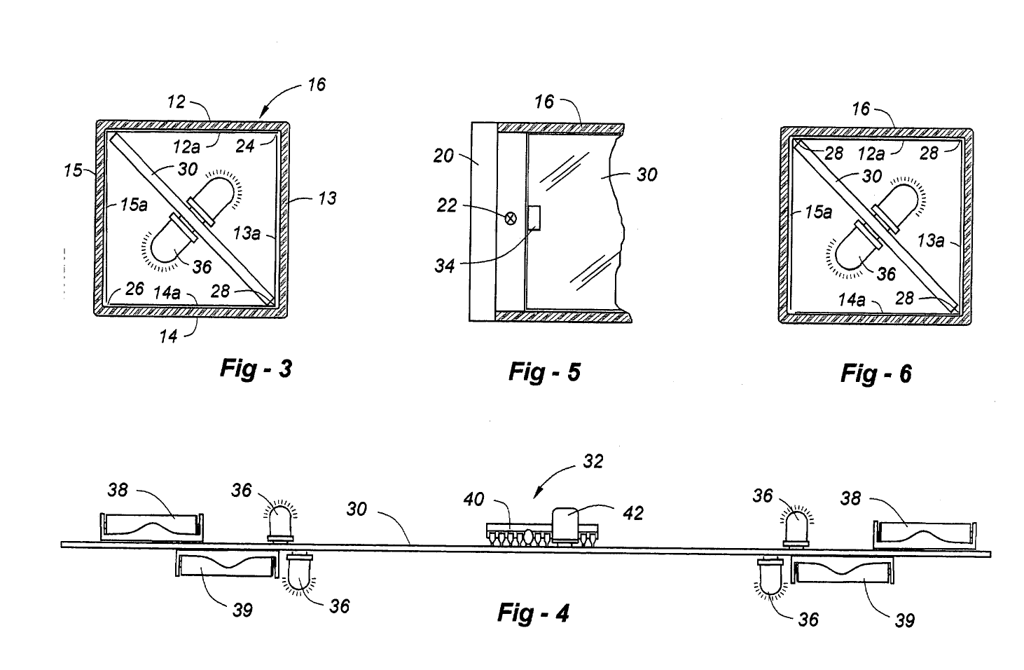

The interior of the tube 16 is provided with a plurality of panels 12a, 13a, 14a and 15a bearing text and graphics and printing in various selected colors and style to convey advertising messages. The panels 12a through 15a are shown disposed in close proximity to the inside surfaces of the respective sidewalls 12 through 15. Preferably the advertising panels are formed of paper or thin plastic material, and are joined or folded along a common line between adjoining panels. As seen in FIGS. 2 and 3 the advertising panels 12a and 13a are joined together at the fold line 24 and panels 14a and 15a are joined at the fold line 26. Alternatively all of the panels 12a, 13a, 14a, and 15a can be printed as a unit with fold lines 28 between adjacent panels as seen in FIG. 6.

It will be apparent that the advertising messages can be changed by the establishment selling the merchandise. Also, the advertising message on each of the panels can be the same or preferably can be different so that different messages will be viewable depending upon which of the four surfaces lays in contact with the conveyer forming the counter top.

Disposed within the elongated tube 16 is a printed-circuit board 30, which preferably extends the full length of the tube 16. FIG. 4 shows a preferred physical layout of the board 30. Control circuits 32 are preferably mounted centrally, making double-sided connections to batteries 38, motion detector 34, and light-emitting diodes 36. Holders 39 are provided so that one or all batteries can be mounted on either side of the board 30.

The motion detector 34 is preferably fixed at one end of the board 30 so that when the latter is supported within the tube 16, the motion detector 34 will be in close proximity to the transparent end wall 18. Multiple motion detectors may also be used in different locations (i.e., see item 50′ in FIG. 8). Two light-emitting diodes (LEDs) are supported on each side of the mounting board enabling each pair to backlight two sides of the housing.

Broadly, the control circuitry 32 is responsive to external lighting variations detected by motion detector 34, causing the LEDs 36 to flash and attract attention to the advertising. After a predetermined period of time as explained below, the lights go off to initiate another cycle. The LEDs 36 can be programmed to flash or to remain illuminated for a predetermined period of time such as twenty or thirty seconds and then operation can be terminated. Although the lights may come on and remain illuminated, flashing is used to conserve battery power and draw more attention to the divider bar.

In use, the divider 10 is used in much the same manner as conventional dividers, in that it is handled by the customer in a conventional manner and is placed on a conveyer forming a counter to separate the customer's selected merchandise from the merchandise of the prior customer. By approaching the checkout stations or by moving the divider 10 and placing it on the conveyer, the motion detector 34 signals the control circuits 32, and the LED's 36 are individually and sequentially illuminated to flash and/or back-light the advertising panels 12a-15a. The LED's 36 serve to call the attention of the customer and surrounding observers. As the customer's merchandise approaches the cashier's station, the divider 10 is removed from the conveyer and returned to a storage place from which subsequent customers may select one of the dividers for use.

The control circuit 32 is preferably based on a microcontroller including an on-chip analog-to-digital (A-D) converter. The analog input of the microcontroller is wired to a voltage divider circuit including a fixed-value resistor and the motion detector 34 in the form of a photo-reactive resistor. The PIC12F675 series micro-controller from Microchip Technology, Inc. or other commercially available devices may be used. The timing can be established by a crystal 42. Although a crystal oscillator is shown, other types of oscillators not requiring a crystal may be used. Each of the four outputs of the PIC microcontroller are wired to the cathodes of one of the LEDs 36, which are preferably ultra-bright or superbright devices

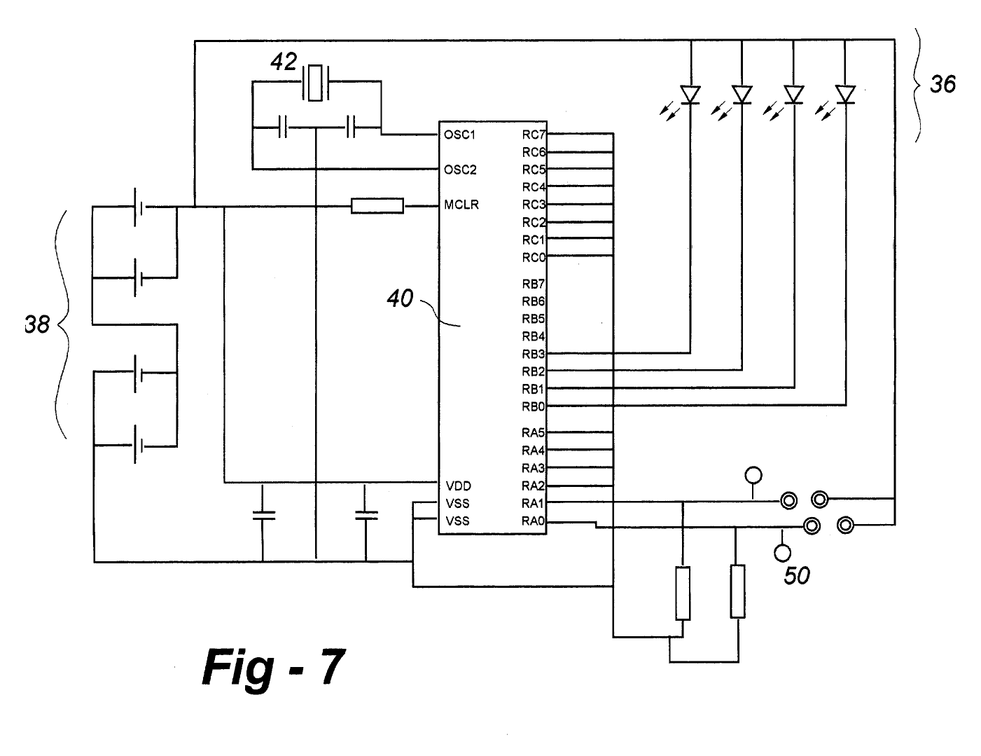

FIG. 7 is a circuit diagram illustrating important electrical components associated with the invention. The microcontroller 40 loops through a program, which looks for, a difference between the most recent and previous values read from the A-D converter. The microcontroller then looks up a number from an array of values which is scaled to the last read value, and determines if the change or difference in the light seen by the photoreactive resistor 34 is great enough to be considered a valid interpretation of motion.

Upon determination of valid motion detection, the microcontroller then enters a timed loop, which alters the state of the outputs in a sequential fashion. One of each of the four LEDs 36 are activated. The active LED is left in the conductive (lighted) state for a duration of 40 milliseconds, and then is forced into a non-conductive state of 80 milliseconds. After the completion of this single LED on/off cycle, the program then performs the same functionality upon the next LED within the ordered sequence. This pattern of flashing each LED for the same duty cycle of thirty-three percent on, and sixty-seven percent off, continues for a duration of 10 seconds. Following this flashing loop is a sleep time of 5 seconds. The sleep mode conserves the batteries by reducing the current consumption to four percent of the normal operational consumption of the microcontroller.

A counter divider for checkout counters has been provided which is made of transparent material to form an elongated tube of polygonal cross-section in which advertising panels are positioned to be displayed through each of the sides of the divider. Disposed within the tube and concealed by the advertising material is a mounting board which supports the light source, power source and its controls and which, when energized due to motion, causes the light source(s) to be energized, calling attention to the advertising material and the messages contained on the panels.

I claim:

1. A divider bar of the type used to separate purchases on a conveyor belt at a check-out station, comprising:
an elongated form having a plurality of panels, at least one of which exposes textual or graphical information; and
electronics disposed within the form, including:
at least one lamp configured to back-light the textual or graphical information, and
a motion detector operative to activate the lamp in response to motion detected outside the form.

2. The divider bar of claim 1, wherein the motion detector is a light sensor.

3. The divider bar of claim 1, wherein the lamp operates for a predetermined period of time following activation then automatically turns off.

4. The divider bar of claim 1, wherein the lamp is a flashing light-emitting diode.

5. The divider bar of claim 1, wherein:
the panel is constructed of transparent plastic; and
the textual or graphical information is printed on a sheet supported within the form behind the panel.

6. The divider bar of claim 1, wherein:
the form has square or rectangular cross section having four panels constructed of transparent plastic; and
the textual or graphical information is printed on a single sheet supported within the form behind the panel.

7. The divider bar of claim 1, wherein:
the form has square or rectangular cross section having four panels constructed of transparent plastic;
the textual or graphical information is printed on a single sheet supported within the form behind the panel; and
a plurality of the lamps are mounted on both sides of a circuit board disposed diagonally within the form so that each lamp backlights a pair of the panels.
